(19) United States
(12) Patent Application Publication
(10) Pub. No.: US 2013/0175927 A1
(43) Pub. Date: Jul. 11, 2013

(54) PLASMA TREATMENT APPARATUS USING LEAKAGE CURRENT TRANSFORMER

(71) Applicant: Je Won Lee, Gimhae-si (KR)

(72) Inventor: Je Won Lee, Gimhae-si (KR)

(73) Assignee: INJE UNIVERSITY INDUSTRY-ACADEMIC COOPERATION FOUNDATION, Gimhae-si, Gyeongsangnam-do (KR)

(21) Appl. No.: 13/822,745

(22) PCT Filed: Sep. 16, 2011
(86) PCT No.: PCT/KR2011/006830

§ 371 Date: Mar. 13, 2013

(30) Foreign Application Priority Data
Sep. 17, 2010 (KR) 10-2010-0091544

(51) Int. Cl. H05H 1/24

(52) U.S. Cl. CPC H05H 1/24
USPC 315/110; 315/111.21

(57) ABSTRACT

Provided is a plasma treatment apparatus using a leakage current transformer, the apparatus, including: a chamber which provides a closed space in which plasma is formed, and receives a treated sample in an inner part thereof; an exhaust unit for forming the inner part of the chamber in a vacuum state; plasma generation electrodes fixed in the chamber, positive and negative poles of which are installed to be opposed to each other; a variable power supply which is installed in an outer part of the chamber and supplies a power source to the plasma generation electrodes; and a leakage current transformer which is installed between the variable power supply and the plasma generation electrodes and adjusts voltage and current applied to the plasma generation electrodes.

### CROSS-REFERENCE TO RELATED APPLICATION

This application claims priority to Korean Patent Application No. 10-2010-0091544, filed on Sep. 17, 2010, in the Korean Intellectual Property Office, the entire contents of which are hereby incorporated by reference.

### BACKGROUND OF THE INVENTION

1. Field of the Invention

The present invention relates to a vacuum plasma treatment apparatus using a leakage current transformer, and more specifically, to a plasma treatment apparatus which can perform surface treatments such as etching and deposition using a neon transformer or a cold cathode transformer which are a vacuum reactor and a leakage current transformer.

2. Description of the Related Arts

Plasma means ionized gas. When a gas composed of atoms or molecules is discharged using electric energy, plasma composed of electrons, ions, decomposed gases and photons and the like is formed.

Surface treatment using this plasma is called a plasma surface treatment method. That is, the plasma surface treatment method is a surface treatment method which includes: converting a predetermined raw material gas such as oxygen into a plasma gas; and physically and chemically reacting the plasma gas with a surface of an object to be treated, thereby modifying the surface.

Meanwhile, in the case of a dry surface treatment method using plasma, a surface may be more uniformly and accurately treated compared to a wet surface treatment method, and it is easy to control the surface. Furthermore, since gas such as oxygen, argon and the like is used in the dry surface treatment method using plasma, a pollutant is hardly generated compared to the wet surface treatment method.

Hereinafter, it will be schematically explained about a surface treatment apparatus using plasma.

The plasma surface treatment apparatus may be divided into a capacitively coupled plasma type and an inductively coupled plasma type according to the kind of plasma generation electrodes. The capacitively coupled plasma type of these plasma types has been widely used and an apparatus for generating plasma using the capacitvely coupled plasma type is called a capacitively coupled plasma (CCP) generation apparatus.

The capacitively coupled plasma generation apparatus uses the charge accumulation principle of a condenser and has a structure in which two electrodes are formed in an inner part of a chamber to be opposed to each other so that a high frequency electric power or a low frequency electric power, a direct current power or a pulse power having time modulation with regard to these electric powers can be applied to one electrode.

Furthermore, in the capacitively coupled plasma generation apparatus, the electrodes function to generate and maintain the plasma according to an interaction by a collision between charged particles or a collision between charged particles and electrodes. Electrostatic fields between two electrodes result in acceleration of the charged particles such as electrons and ions.

At this time, it would be important to form two electrodes to have a sufficient difference in voltage therebetween so that plasma can be generated. In generally, one electrode is directly grounded or it is grounded against a separated condenser, a coil (an inductor) or a combination of the condenser and the coil.

In the conventional capacitively coupled plasma generation apparatus, a method of transmitting electric power for plasma generation using a radio frequency or an alternating current power supply for generating an alternating current with regard to dry etching, chemical deposition and surface modification has been most commonly used in industry and research fields. The reason is because heat and an arc are frequently generated and it would be relatively difficult to generate a stable low-temperature plasma when the direct current power instead of the alternating current power is used.

However, due to high cost for buying and maintaining the alternating current power supply and the radio frequency one which have been industrially utilized for plasma generation up-to-date, a large financial burden has been required.

In particular, in a case where the radio frequency is used, high-priced radio frequency generation apparatus and a separate matching box should be used together so that the impedance of a power apparatus can be optimized. In general, it would be difficult to stably generate a radio frequency plasma without the use of the separate additional matching box.

Accordingly, the present invention provides a plasma generation apparatus using the neon transformer or the cold cathode transformer, which is the leakage current transformer having an excellent cost reduction effect and capable of being easily obtained in surroundings.

That is, the leakage current transformer is a transformer which can adjust the intensity of a second current by connecting the leakage leg of magnetic flux onto a magnetic circuit using a leakage iron core. The neon transformer is one of the leakage current transformers and is used for supplying a high voltage power of 4,000 to 1,5000V to car or indoor and outdoor neon signs and supplies a constant current of about 50 mA to the second power source unit using a leakage current principle.

In the past, the neon transformer was intensively used for the development of atmospheric plasma. There are many reports concerning an apparatus for generating plasma at atmospheric pressure and in the water (i.e. Korean Laid-Open Patent Publication No. 2006-0091869 and Japanese Laid-Open Patent Publication No. 2004-311251).

However, like the conventional apparatus, when the plasma is generated using the neon transformer in an atmospheric pressure state, the following problems are generated. 1) In the atmospheric pressure state, a distance between two plasma electrodes is severely limited. That is, regarding plasma discharge, according to the Paschen's law, to easily cause the plasma discharge, as pressure increases, a distance between the electrodes should be reduced. Accordingly, in the case of atmospheric pressure, the distance between the electrodes should be reduced up to several millimeter. 2) Also, when the neon transformer is used for plasma discharge at the atmospheric pressure, a relatively high voltage should be applied to both electrodes. At this time, an arc may be easily generated from a metal or between the conductive electrodes. That is, when the arc is generated from the plasma apparatus due to the high voltage (more than about 5,000V), an electrical circuit can easily break down and become unstable due to the electrical flow of the high voltage and current. Thus, in the plasma generation apparatus using the neon transformer at atmospheric pressure, a ceramic or plastic insulator is generally inserted between two plasma electrodes.

Briefly speaking, there are efforts to solve the technical issues of the two problems above; i.e. 1) In the case of atmospheric pressure, the high voltage should be applied between the plasma electrodes, and 2) when high voltage is applied, the electrical circuit can easily break down because the arc is generated, so the insulator should be inserted between the plasma electrodes. Again it caused, the distance between the plasma electrodes to be reduced up to several millimeter when the neon transformer is used, and the generation of the atmospheric plasma required to use the insulator between the plasma electrodes for safely.

However, when the distance between the plasma electrodes is too narrow, there is a limitation of plasma application to the surface treatment of materials which have various sizes using plasma. For example, when a thickness of the material is more than 10 cm or when a surface of the material has an inflexed shape, there is a limit to the surface treatment using the atmospheric plasma.

Furthermore, when the material has a doughnut shape, a problem with the plasma treatment of an inner surface is generated.

### SUMMARY OF THE INVENTION

The present invention has been made to solve the problems above. An aspect of the present invention provides a plasma treatment apparatus which has a simple structure with a stable generation of an alternating plasma using a leakage current transformer and a variable power supply, which can be used as a power source for buildings or vehicles.

According to an aspect of the present invention, there is provided a plasma treatment apparatus, including: a chamber which provides a closed space in which plasma is formed, and receives a treated sample in an inner part thereof; an exhaust unit for forming the inner part of the chamber in a vacuum state; a plasma generation electrodes fixed into the chamber, positive and negative poles of which are installed to be opposed to each other; a variable power supply which is installed in an outer part of the chamber and supplies a power source to the plasma generation electrodes; and a leakage current transformer which is installed between the variable power supply and the plasma generation electrodes and adjusts voltage and current applied to the plasma generation electrodes.

A fixture for fixing the treated sample may be provided on the plasma generation electrodes.

Any one of the positive and negative poles of the plasma generation electrodes may be installed on an upper part of the chamber, and another one may be installed on a lower part of the chamber.

The fixture for fixing the treated sample may be provided on the electrode installed in the lower part of the chamber.

The leakage current transformer may be a neon transformer or a cold cathode transformer.

At least one of the positive and negative poles of the plasma generating electrodes may be formed in plural number.

The neon transformer may be configured such that the plurality of neon transformers are installed between the variable power supply and the plasma generation electrodes in parallel.

The neon transformer may use an input voltage of 1 to 500V and an output voltage of 1 to 25,000V.

The variable power supply may include a dimmer which is able to adjust the intensity of voltage and current applied to the neon transformer using an analogue method or a digital method.

The variable power supply may include an ammeter and a voltmeter which display a primary power source applied to the leakage current transformer.

The plasma treatment apparatus may further include an earth electrode which is installed in the chamber so that the chamber is grounded.

The fixture for fixing the treated sample may be provided on the earth electrode.

The exhaust unit may include: at least one pressure-regulating valve for adjusting an internal pressure of the chamber; and a vacuum pump provided with at least one of a low vacuum pump including a rotary pump, a booster pump and a dry pump, and a high vacuum pump including a turbo molecular pump, a diffusion pump and a Cryo pump.

The plasma treatment apparatus may further include sub-electrodes which are disposed in the inner part of the chamber so as to adjust the density and intensity of plasma generated from the plasma generation electrodes.

According to the present invention, the plasma treatment apparatus stably generates the alternating current plasma using the leakage current transformer and the variable power supply. Thus, the following effects can be provided. First, the plasma apparatus is simplified by removing a high-priced additional matching box and using components which can be easily obtained in surroundings.

Second, as a voltage measuring unit and a current measuring unit are installed in the primary power source, excellent power control conditions can be consequently provided during plasma treatment.

Third, as a single-phase commercial power source is used as the primary power source, the plasma treatment apparatus can use a domestic power source or even an automobile power source.

Forth, as the plurality of neon transformers are connected between one variable power supply and the plasma electrode unit in parallel, the applied current can be widely adjusted.

Fifth, as the alternating current plasma is generated using the plurality of electrode units in a vacuum state, the voltage applied to the electrode units having a sample thereon can be reduced and the density of plasma in the inside of a reactor can be suitably increased.

Sixth, according to the present invention, the plasma treatment apparatus, which is economical and easy to maintain and repair compared to a convention plasma treatment apparatus, can be provided, and various surface treatment processes for materials can be performed.

### BRIEF DESCRIPTION OF THE DRAWINGS

The accompanying drawings are included to provide a further understanding of the present invention, and are incorporated in and constitute a part of this specification. The drawings illustrate exemplary embodiments of the present invention and, together with the description, serve to explain principles of the present invention. In the drawings:

FIG. 1 is a block diagram showing a plasma treatment apparatus using a leakage current transformer according to one exemplary embodiment of the present invention.

FIG. 2 through FIG. 6 are block diagrams showing a plasma treatment apparatus using a leakage current transformer according to various exemplary embodiments of the present invention.

### DETAILED DESCRIPTION OF THE INVENTION

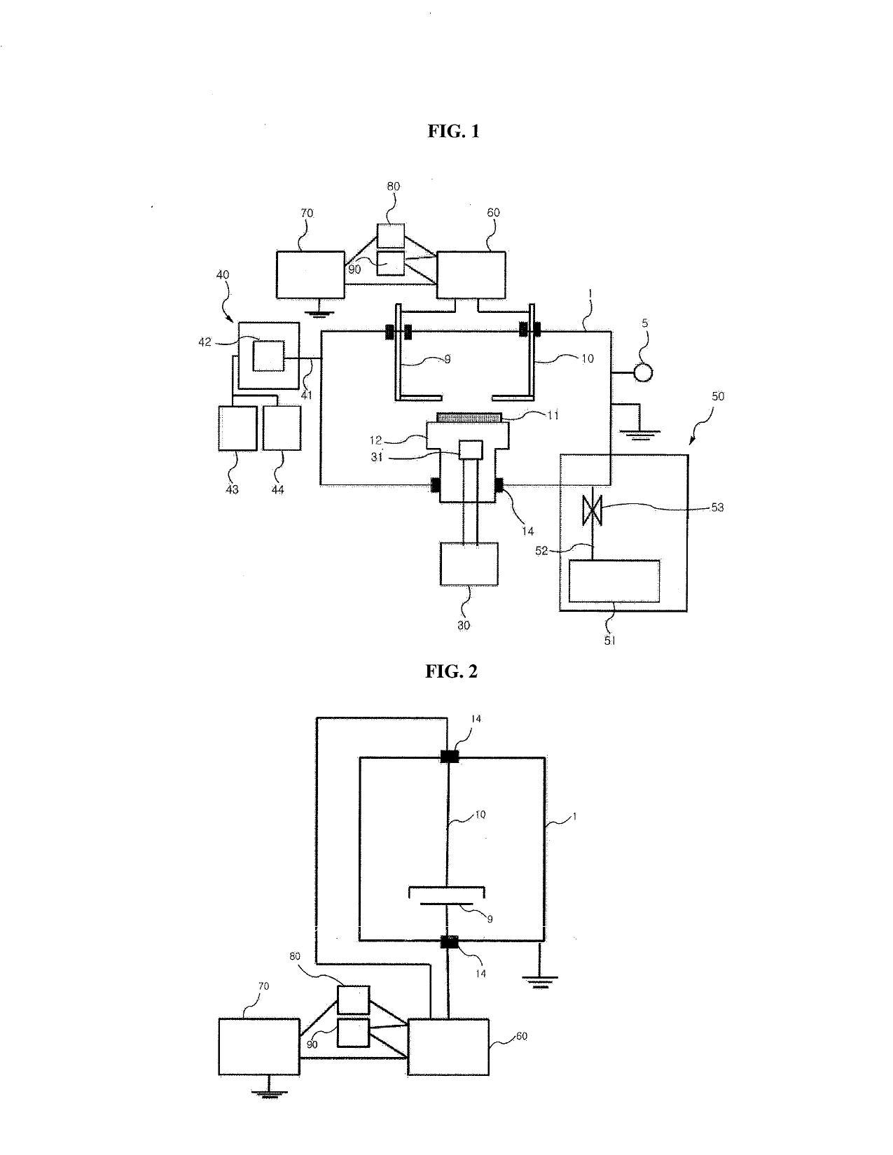

Hereinafter, exemplary embodiments according to the present invention will now be described more fully with reference to the accompanying drawings, FIG. 1 through FIG. 6. The exemplary embodiments of the present invention may, however, be embodied in many different forms and should not be construed as limited to the embodiments set forth herein. Rather these example embodiments are provided so that this disclosure will be thorough and complete, and will fully convey the scope of the invention to those skilled in the art. Further, it should be understood that the shape and size of the elements shown in the drawings may be exaggeratedly drawn to provide an easily understood description of the structure of the present invention. Also, a leakage current transformer used in the present invention is divided into an electrical type and an electronic type. How to use it is not limited.

FIG. 1 is a block diagram showing a plasma treatment apparatus using a leakage current transformer according to one exemplary embodiment of the present invention. A plasma treatment apparatus using a leakage current transformer includes: a chamber 1; plasma generation electrodes 9, 10; a gas supply unit 40; a leakage current transformer 60; an exhaust unit 50; and a variable power supply 70.

The chamber 1 is a space which divides an outer part and an inner part of the apparatus. An external surface of the chamber is formed of a conductor such as stainless steel and aluminum, or a nonconductor using quartz, teflon and the like.

As the chamber 1 is formed in a closed structure, an inner part of the chamber is maintained in a vacuum state which is an advantageous environment for using a reactive gas such as O₂, SF₆, Cl₂, SiH₄ and the like. The gas supply unit 40, the exhaust unit 50 and a vacuum pressure gauge 5 is connected to the chamber 1.

A grounded electrode 11 is installed in a lower part of the inner part of the chamber, and an electrical resistance hot wire 31 are inserted into an inner part of the grounded electrode 11 so as to supply heat as necessary. The electrical resistance hot wire 31 is connected to a heat power supply 30 so that a temperature is controlled. Furthermore, the electrical resistance hot wire 31 may be replaced with a halogen lamp.

According to the present exemplary embodiment, a thermostat regulator for controlling the temperature of the electrical resistance hot wire 31 uses a PID control method. However, as needed, a holding circuit may be used together or simple on/off control may be adopted. In a case where it is required to maintain a low temperature, a heat exchanger may be also used.

Meanwhile, as described above, the heat may be directly supplied into the inner part of the chamber 1, but when a material of the chamber 1 is quartz and the like, the heat may be supplied using a heat source which surrounds entirely or partially an outer surface of the chamber.

The plasma generation electrodes 9, 10 and a chuck 12 are disposed in an upper part of the inner part of the chamber 1. The plasma generation electrodes 9, 10 are connected to a neon transformer or a cold cathode transformer which is the leakage current transformer 60.

The plasma generation electrodes 9, 10 have a structure in which the positive and negative poles oppose to each other. Furthermore, the plasma generation electrodes 9, 10 are electrically insulated from the chamber 1 with an insulator 14 and have a shape such as a circular shape, a rectangular shape and the like. However, the shape of the plasma generation electrodes 9, 10 is not limited to this.

Here, an important matter is that one plasma generation electrode and one earth electrode are required in the conventional radio frequency, but two plasma electrodes are independently required when the neon transformer or the cold cathode transformer is used. A distance between two plasma generation electrodes may be determined according to the optimization of an apparatus and a size of the chamber. However, the distance is not specially limited if two electrodes are electrically separated from each other.

As described above, the neon transformer is a kind of representative leakage current transformer 60 and usually uses a power source of about 1 to 500V, preferably about 12 to 220V, as a primary input power source. Generally, an output voltage is about 1 to 20,000V. The intensity of the output voltage generated at this time may be adjusted by the variable power supply 70.

The variable power supply 70 may be produced using a transistor or a commonly used slidacs or dimmer. In the present exemplary embodiment of the present invention, the dimmer is used as the variable power supply 70. Compared to the slidac, the dimmer is cheap and has a small volume. Furthermore, the dimmer can be easily repaired when it is broken.

Meanwhile, the ammeter and the voltmeter are connected between the variable power supply 70 and the neon transformer 60 so that the values of the primary voltage and current applied to the leakage current transformer 60 are accurately displayed.

A sample to be treated with the plasma treatment apparatus according to the present invention is put on the plasma generation electrodes 9, 10 or the grounded electrode 11. When a plasma etching or depositing process is performed at room temperature, the treated sample is generally placed on the plasma generation electrodes. To perform surface modification or deposition at a high temperature, the sample is put on the heated grounded electrode 11.

However, in the plasma treatment apparatus, a position of the treated sample is not limited. The treated sample may be arbitrarily placed on the plasma generation electrodes 9, 10 or the grounded electrode 11. For this, a fixture (not drawn) for fixing the treated sample is provided onto the plasma generation electrodes 9, 10 or the grounded electrode 11.

Meanwhile, the gas supply unit 40 for supplying a reaction gas into the chamber 1 includes: a gas supply line 41, a gas flow regulator 42, a gas tank 43, an evaporator 44 and the like.

That is, the reaction gas in a gas state such as oxygen stored in the gas tank 43 is directly supplied into the chamber through the gas supply line 41 or the reaction gas is stored in the evaporator 44 and is mixed with a material in a liquid or solid state, which is evaporated by the evaporator 44 and is used as a precursor for surface treatment using deposition and etching processes, thereby being supplied to the chamber 1. The pressure and flow of the reaction gas are adjusted with the gas flow meter 41.

Meanwhile, as the reaction gas, a gas including an oxygen content such as O₂, N₂O and the like, a gas including a fluorine content such as CF₄, SF₆ and the like, a gas including a chlorine content such as Cl₂, BCl₃ and the like, an evaporation gas such as Sinₜ, NH₃ and the like, and an inert gas such as Ar, N₂ and the like may be used separately or by mixture.

The exhaust unit 50 is composed of at least one pressure regulating valve 53 for adjusting an internal pressure of the chamber 1, a vacuum valve 53 and an exhaust line 52. One or more vacuum pumps of low vacuum pumps including a rotary pump, a booster pump and a dry pump, and high vacuum pumps including a turbo molecular pump, a diffusion pump and a cryo pump may be used as the vacuum pump 51. Furthermore, the exhaust unit 50 maintains the chamber 1 in a vacuum state or exhausts gas in the chamber 1.

FIG. 2 through FIG. 6 are block diagrams showing a plasma treatment apparatus using a leakage current transformer according to various exemplary embodiments of the present invention. Referring to FIG. 2 through FIG. 6, a plasma treatment apparatus using a leakage current transformer according to various exemplary embodiments of the present invention will be hereinafter explained in detail.

In the exemplary embodiment as disclosed in FIG. 2, the plasma generation electrodes 9, 10 are installed in the upper and lower parts of the chamber 1 to be opposed to each other. The plasma generation electrode 9 of the lower part is formed so as to have a chuck function for fixing the treated sample.

Meanwhile, the elements such as the leakage current transformer to which the plasma generation electrodes 9, 10 are connected, the variable power supply 70, the ammeter 80 and the voltmeter 90 are identical with those of the exemplary embodiment as disclosed in FIG. 1.

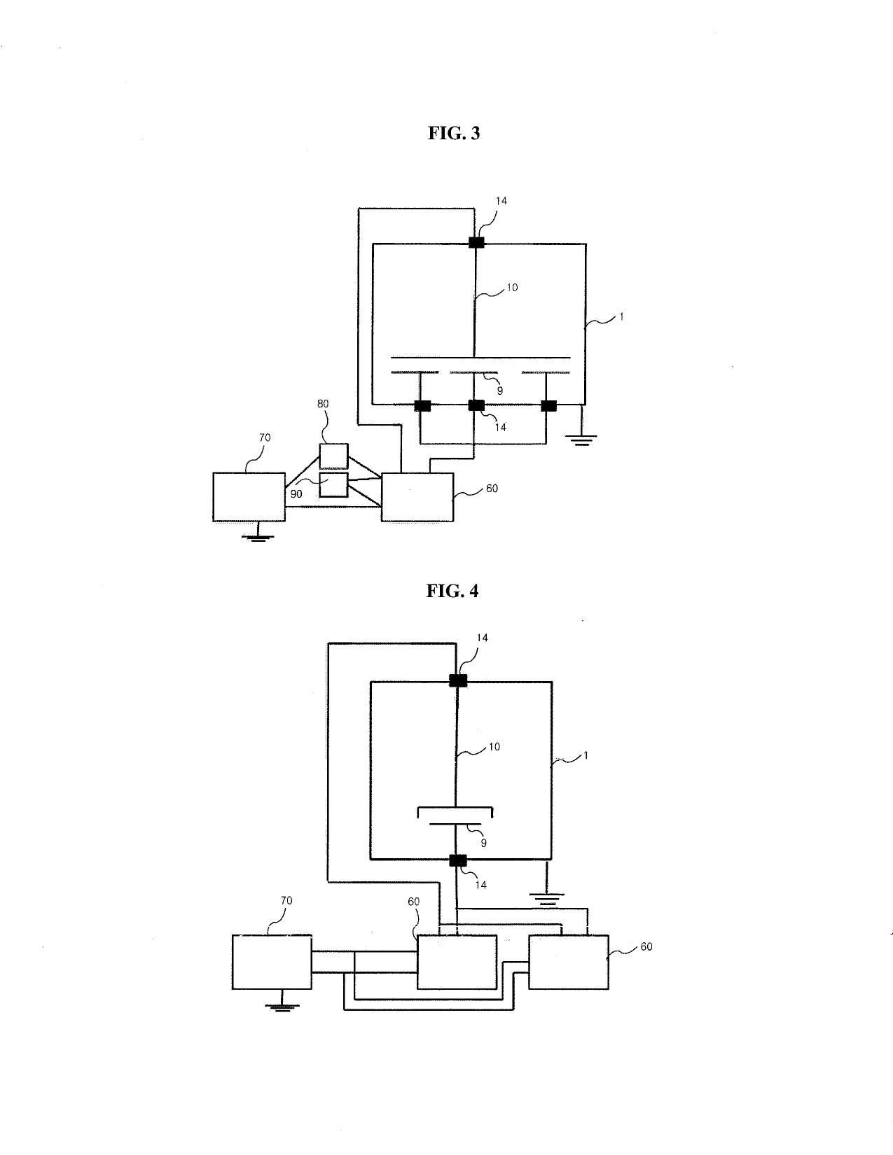

FIG. 3 shows another exemplary embodiment. In the inner part of the chamber 1, one plasma generation electrode 10 is mounted at an upper end, and the plurality of plasma generation electrodes 9 are mounted at a lower end. Each size and shape of the electrodes may be arbitrarily controlled. Furthermore, a power source is supplied to the plasma generation electrodes 9, 10 from the same leakage current transformer 60.

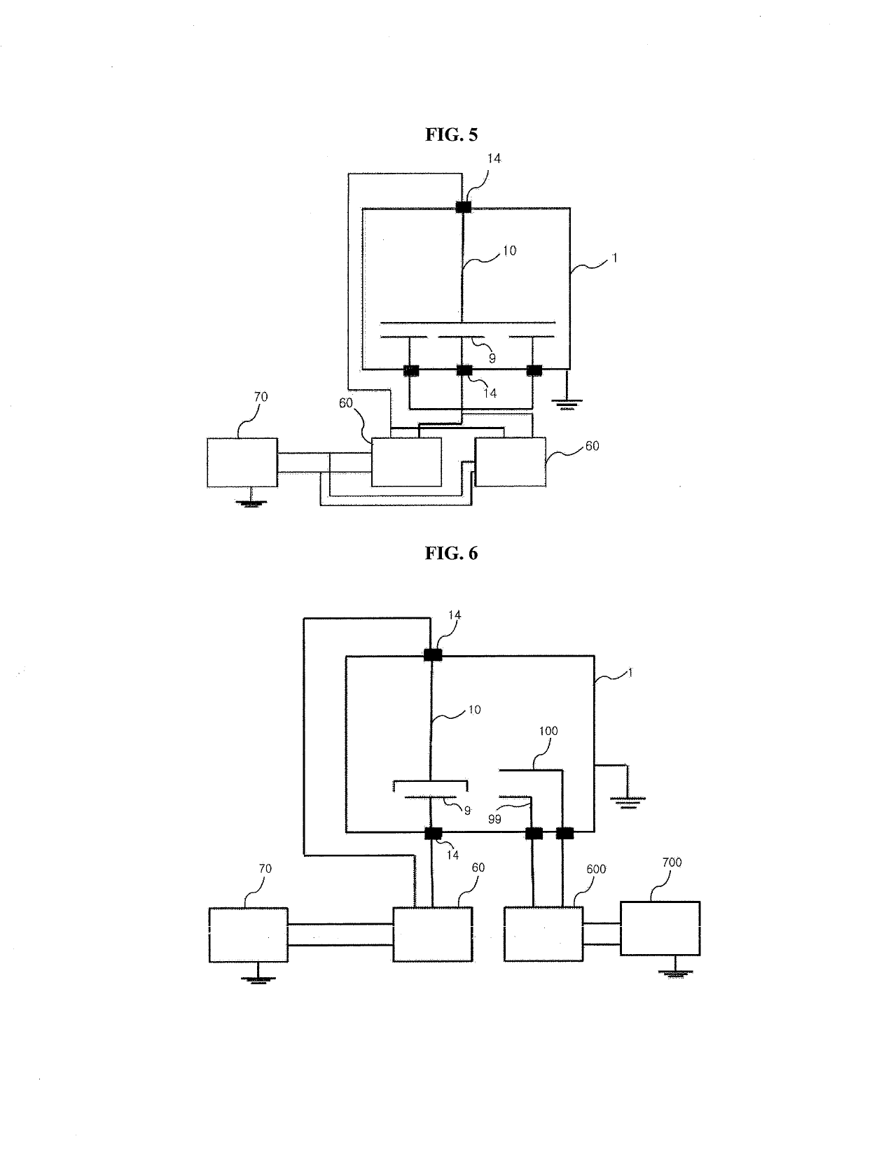

FIG. 4 and FIG. 5 show the element wherein the leakage current transformer 60 for supplying the power source is connected to the plasma generation electrodes 9, 10 of the inner part of the chamber 1 in parallel so that the power source in larger amounts can be supplied.

FIG. 6 shows the element wherein separately from the plasma generation electrodes 9, 10, sub-electrodes 99, 100 for adjusting a density and intensity of plasma are added to the inner part of the chamber 1. A size, shape, number and position of the sub-electrodes 99, 100 may be arbitrarily determined. The neon transformer 600 and the variable power supply 700 for supplying a power source to the sub-electrodes 99, 100 are also added to the inner part of the chamber 1.

As an experimental result based on the present invention which is configured as described above, it could be confirmed that even though an insulator against an electrode surface is not inserted between two plasma generation electrodes, plasma is very stably generated.

Also, even though the plasma generation electrodes are spaced apart from each other at a distance of more than 20 cm, plasma was stably generated. Furthermore, even though a ceramic element is inserted between two electrodes in parallel or is removed from the electrodes, plasma is uniformly generated.

In two cases as mentioned above, an arc between two electrodes was not seen. Also, the generation intensity of plasma could be also easily adjusted using the variable voltage supply. In practice, the input voltage of the neon transformer enabled an etching experiment of a material to be successfully carried out even in a low voltage of tens of volts. An etching speed of about more than 50 nm/min could be easily obtained in an air plasma atmosphere during the etching of acryl.

Also, even in a case where multilayered electrodes are required for performing the surface treatment of materials in large quantities, in the inner part of the chamber in which the vacuum state is formed, a distance between the electrodes and the number of electrode layers are not limited.

As described above, referring to the drawings, it is explained about the plasma treatment apparatus of the present invention which may cause the deposition and etching of a substance, and surface modification using the neon transformer and the variable power supply which are the leakage current transformer. Furthermore, in the detailed description of the invention, having described the detailed exemplary embodiments of the invention, it should be apparent that modifications and variations can be made by persons skilled without deviating from the spirit or scope of the invention. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims and their equivalents.

What is claimed is:

1. A plasma treatment apparatus using a leakage current transformer, the apparatus, comprising:
a chamber which provides a closed space in which plasma is formed, and receives a treated sample in an inner part thereof;
an exhaust unit for forming the inner part of the chamber in a vacuum state;
plasma generation electrodes fixed in the chamber, positive and negative poles of which are installed to be opposed to each other;
a variable power supply which is installed in an outer part of the chamber and supplies a power source to the plasma generation electrodes; and
a leakage current transformer which is installed between the variable power supply and the plasma generation electrodes and adjusts voltage and current applied to the plasma generation electrodes.

2. The plasma treatment apparatus of claim 1, wherein a fixture for fixing the treated sample is provided on the plasma generation electrodes.

3. The plasma treatment apparatus of claim 1, wherein one of the positive and negative poles of the plasma generation electrodes is installed on an upper part of the chamber, and another one is installed on a lower part of the chamber.

4. The plasma treatment apparatus of claim 3, wherein the fixture for fixing the treated sample is provided on the electrode which is installed in the lower part of the chamber.

5. The plasma treatment apparatus of claim 1, wherein the leakage current transformer is a neon transformer or a cold cathode transformer.

6. The plasma treatment apparatus of claim 5, wherein at least one of the positive and negative poles of the plasma generation electrodes is formed in plural number.

7. The plasma treatment apparatus of claim 5, wherein the neon transformer or the cold cathode transformer is configured such that the plurality of neon transformers or cold cathode transformers are installed between the variable power supply and the plasma generation electrodes in parallel.

8. The plasma treatment apparatus of claim 5, wherein the neon transformer uses an input voltage of 1 to 500V and an output voltage of 1 to 25,000V.

9. The plasma treatment apparatus of claim 1, wherein the variable power supply includes a dimmer which is able to adjust an intensity of voltage and current applied to the neon transformer using an analogue method or a digital method.

10. The plasma treatment apparatus of claim 1, wherein the variable power supply includes an ammeter and a voltmeter which display a primary power source applied to the leakage current transformer.

11. The plasma treatment apparatus of claim 1, further comprising an earth electrode which is installed in the chamber so that the chamber is grounded.

12. The plasma treatment apparatus of claim 11, wherein the fixture for fixing the treated sample is provided on the earth electrode.

13. The plasma treatment apparatus of claim 1, wherein the exhaust unit includes: at least one pressure-regulating valve for adjusting pressure in the inner part of the chamber; and a vacuum pump provided with at least one of a low vacuum pump including a rotary pump, a booster pump and a dry pump, and a high vacuum pump including a turbo molecular pump, a diffusion pump and a Cryo pump.

14. The plasma treatment apparatus of claim 1, further comprising sub-electrodes which are provided in the inner part of the chamber so as to adjust a density and intensity of plasma generated by the plasma generation electrodes.
